(19) United States
(12) Patent Application Publication
(10) Pub. No.: US 2008/0273893 A1
(43) Pub. Date: Nov. 6, 2008

(54) SUBSTRATE TRANSFER MEMBER CLEANING METHOD, SUBSTRATE TRANSFER APPARATUS, AND SUBSTRATE PROCESSING SYSTEM

(75) Inventors: Jun YAMAWAKU, Nirasaki-shi (JP); Tsuyoshi Moriya, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/053,211

(22) Filed: Mar. 21, 2008

Related U.S. Application Data
(60) Provisional application No. 60/938,732, filed on May 18, 2007.

(30) Foreign Application Priority Data
Mar. 28, 2007 (JP) 2007-085429

(51) Int. Cl. G03G 15/16

(52) U.S. Cl. 399/101

(57) ABSTRACT

A substrate transfer member cleaning method that enables foreign matter attached to a substrate transfer member to be completely removed without bringing about a decrease in the throughput. A cleaning agent containing a cleaning substance in two phases of a vapor phase and a liquid phase and a high-temperature gas is jetted toward the substrate transfer member that transfers a substrate.

### BACKGROUND OF THE INVENTION

1. Field of the Invention

The present invention relates to a substrate transfer member cleaning method, a substrate transfer apparatus, and a substrate processing system, and in particular to a method of cleaning a substrate transfer member to which foreign matter is attached.

2. Description of the Related Art

In general, in substrate processing apparatuses that carry out predetermined processing on wafers for semiconductor devices (hereinafter referred to merely as “wafers”), reaction product such as fluorocarbon-based polymer is produced due to reaction of a processing gas. Such foreign matter (particles) becomes attached to a mounting stage on which a wafer is mounted in the substrate processing apparatus, and becomes attached to the wafer mounted on the mounting stage. If the foreign matter becomes attached to wafers, then a short circuit will occur in products such as semiconductor devices manufactured from the wafers, resulting in the yield of the semiconductor devices decreasing.

The present applicant has thus proposed a method in which the temperature of the mounting stage in the substrate processing apparatus is controlled so as to make the temperature of the mounting stage sufficiently higher or lower than a normal operating temperature so that removal of foreign matter attached to the mounting stage can be induced through thermal stress, and a method in which foreign matter attached to the mounting stage is scattered away from the mounting stage through thermal migration force produced by maintaining the mounting stage at a high temperature and maintaining the interior of the substrate processing apparatus at a predetermined pressure (see, for example, the specification of Japanese Patent Application No. 2004-218939).

In the substrate processing apparatus, however, metallic pieces, for example, metallic pieces of aluminum are also produced in the substrate processing apparatus due to contact between a wafer and the mounting stage. Moreover, reaction product as foreign matter cannot be completely scattered away from the mounting stage even by carrying out the above described method. Such foreign matter becomes attached to a rear surface and a peripheral portion (bevel) of the wafer. When the wafer is being transferred, the foreign matter attached to the rear surface and the peripheral portion of the wafer becomes attached to a substrate transfer member that transfers the wafer, for example, a fork of a transfer arm. The foreign matter attached to the fork becomes attached to a wafer again when the wafer is being transferred, and thus has to be completely removed. To completely remove the foreign matter attached to the fork, the transfer arm has to be stopped so as to clean the fork by hand, which will bring about a significant decrease in the throughput.

### SUMMARY OF THE INVENTION

The present invention provides a substrate transfer member cleaning method, a substrate transfer apparatus, and a substrate processing system, which enable foreign matter attached to a substrate transfer member to be completely removed without bringing about a decrease in the throughput.

Accordingly, in a first aspect of the present invention, there is provided a method of cleaning a substrate transfer member that transfers a substrate, comprising a cleaning gas jetting step of jetting a cleaning gas containing a cleaning substance in two phases of a vapor phase and a liquid phase and a high-temperature gas toward the substrate transfer member.

According to the first aspect of the present invention, the cleaning gas containing the cleaning substance in two phases of a vapor phase and a liquid phase and the high-temperature gas is jetted toward the substrate transfer member. The high-temperature gas removes relatively large foreign matter attached to the substrate transfer member through thermal stress and viscous force. A boundary layer in which the high-temperature gas does not flow arises on the substrate transfer member due to the jetted high-temperature gas, and the liquid-phase cleaning substance enters the boundary layer and becomes attached to the periphery of relatively small foreign matter in the boundary layer. When the cleaning substance becomes attached to the periphery of the relatively small foreign matter, attracting forces such as van del Waals' forces between the foreign matter and the substrate transfer member decrease. Further, the liquid-phase cleaning substance having entered the boundary layer collides with the foreign matter and gives a physical shock to the foreign matter. As a result, the relatively small foreign matter is also removed, so that the foreign matter attached to the substrate transfer member can be completely removed. Moreover, because it is unnecessary to stop the substrate transfer member and clean the substrate transfer member by hand, the foreign matter attached to the substrate transfer member can be completely removed without bringing about a decrease in the throughput.

The first aspect of the present invention can provide a cleaning method, wherein in the cleaning gas jetting step, the cleaning gas is jetted obliquely to the substrate transfer member.

According to the first aspect of the present invention, the cleaning gas is jetted obliquely to the substrate transfer member. The obliquely jetted cleaning substance and high temperature gas push the boundary layer aside along the front surface of the substrate transfer member, and hence part of the relatively small foreign matter can be exposed from the boundary layer. As a result, relatively small foreign matter attached to the substrate transfer member can be reliably removed.

The first aspect of the present invention can provide a cleaning method, wherein in the cleaning gas jetting step, a flow rate of the cleaning gas is fluctuated like pulse waves.

According to the first aspect of the present invention, because the flow rate of the cleaning gas fluctuates like pulse waves, the cleaning substance and the high-temperature gas can be fluctuated in pressure, and hence the physical shock given to the foreign matter by the cleaning substance and the high-temperature gas can be increased. As a result, the removal of the foreign matter can be promoted.

The first aspect of the present invention can provide a cleaning method comprising a first high-temperature gas jetting step of jetting a high-temperature gas toward the substrate transfer member before the cleaning gas jetting step.

According to the first aspect of the present invention, the cleaning gas is jetted toward the substrate transfer member after the high-temperature gas is jetted toward the substrate transfer member. Because the temperature of the substrate transfer member is thus raised in advance, the liquid-phase cleaning substance that has been jetted toward the substrate transfer member and become attached to the substrate transfer member can be immediately evaporated. As a result, when the substrate is being transferred, the liquid-phase cleaning substance does not become attached to a rear surface and a peripheral portion of the substrate, and hence watermarks can be prevented from arising.

The first aspect of the present invention can provide a cleaning method comprising a second high-temperature gas jetting step of jetting a high-temperature gas toward the substrate transfer member after the cleaning gas jetting step.

According to the first aspect of the present invention, the high-temperature gas is jetted toward the substrate transfer member after the cleaning gas is jetted toward the substrate transfer member. Therefore, the evaporation of the liquid-phase cleaning substance attached to the substrate transfer member can be promoted, and hence the liquid-phase cleaning substance can be completely evaporated.

The first aspect of the present invention can provide a cleaning method, wherein the substrate transfer member comprises abutment members that come into abutment with the substrate, and in the cleaning gas jetting step, the cleaning gas is jetted toward the abutment members.

According to the first aspect of the present invention, because the cleaning gas is jetted toward the abutment members that come into abutment with the substrate, foreign matter attached to the abutment members due to abutment of the substrate and the abutment members can be completely removed, and hence the foreign matter can be prevented from becoming attached to the substrate when the substrate is being transferred.

The first aspect of the present invention can provide a cleaning method, wherein the cleaning substance is one selected from a group consisting of water, organic solvent, function water, surface-active agent, and cleaning solution.

According to the first aspect of the present invention, the cleaning substance jetted toward the substrate transfer member is one selected from a group consisting of water, organic solvent, function water, surface-active agent, and cleaning solution. The boiling points of these cleaning substances are relatively low, and hence they can easily be in two phases of a vapor phase and a liquid phase. Moreover, these cleaning substances are apt to become attached to foreign matter, and hence attractive forces between the foreign matter and the substrate can be reliably reduced.

The second aspect of the present invention can provide a substrate transfer apparatus including a substrate transfer member that transfers a substrate, comprising a jetting device adapted to jet a cleaning gas containing a cleaning substance in two phases of a vapor phase and a liquid phase and a high-temperature gas toward the substrate transfer member.

The third aspect of the present invention can provide a substrate processing system comprising a substrate processing apparatus adapted to carry out processing on a substrate and the above substrate transfer apparatus.

The features and advantages of the invention will become more apparent from the following detailed description taken in conjunction with the accompanying drawings.

### BRIEF DESCRIPTION OF THE DRAWINGS

FIG. 1 is a plan view schematically showing the construction of a substrate processing system according to a first embodiment of the present invention;

FIGS. 2A and 2B are views schematically showing the shape of a fork shown in FIG. 1, in which FIG. 2A is a plan view in a state in which a wafer W is supported on the fork, and FIG. 2B is a partially enlarged perspective view showing a tapered pad on a surface of the fork and its vicinity;

FIG. 3 is a sectional view taken along line III-III of FIG. 1;

FIGS. 4A to 4C are views useful in explaining how foreign matter is removed according to the first embodiment, in which FIG. 4A shows a case where only a gas is jetted as a cleaning agent, FIG. 4B shows a case where two-phase pure water and a high-temperature nitrogen gas are jetted as a cleaning agent, and FIG. 4C shows how relatively small foreign matter shown in FIG. 4B is removed;

FIG. 5 is a flow chart of a cleaning process carried out on the surface of the fork according to the first embodiment;

FIG. 6 is a sectional view schematically showing the construction of a transfer module as a substrate transfer apparatus provided in a substrate processing system according to a second embodiment of the present invention;

FIGS. 7A to 7C are views schematically showing the construction of a cleaning agent jetting nozzle shown in FIG. 6, in which FIG. 7A shows the positional relationship between a fork and the cleaning agent jetting nozzle, FIG. 7B is a sectional view taken along line B-B of FIG. 7A, and FIG. 7C is an enlarged view of a portion C shown in FIG. 7B;

FIG. 8 is a view useful in explaining how foreign matter is removed according to the second embodiment; and

FIGS. 9A and 9B are views schematically showing a variation of the fork, in which FIG. 9A is a plan view showing the fork on which a wafer W is supported, and FIG. 9B is a partially enlarged perspective view showing an O-ring on a surface of the fork and its vicinity.

### DETAILED DESCRIPTION OF THE PREFERRED EMBODIMENTS

The present invention will now be described in detail with reference to the drawings showing preferred embodiments thereof.

First, a description will be given of a substrate processing system according to a first embodiment of the present invention.

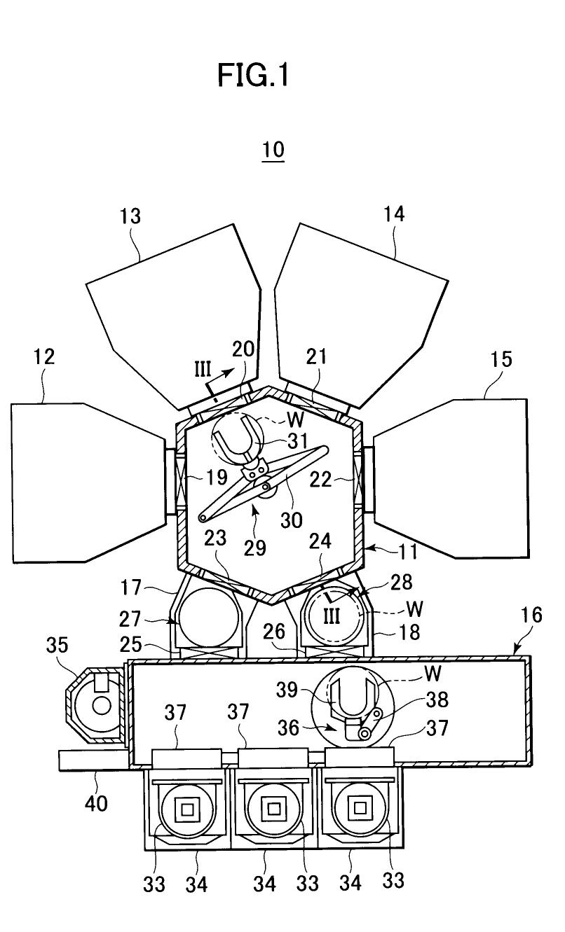

FIG. 1 is a plan view schematically showing the construction of the substrate processing system according to the present embodiment.

As shown in FIG. 1, the substrate processing system 10 is comprised of a transfer module 11 (substrate transfer apparatus) that is hexagonal in plan view, four process modules 12 to 15 disposed radially around the transfer module 11, a loader module 16 (substrate transfer apparatus) as a rectangular common transfer chamber, and two load-lock modules 17 and 18 that are disposed between the transfer module 11 and the loader module 16 and connect the transfer module 11 and the loader module 16 together.

The process modules 12 to 15 are substrate processing apparatuses that carry out predetermined processing on a wafer W for a semiconductor device (hereinafter referred to merely as a “wafer W”). For example, the process module 12 is an etching processing apparatus that subjects a wafer W to etching processing using plasma.

In the substrate processing system 10, the interiors of the transfer module 11 and the process modules 12 to 15 are held in a vacuum, and the transfer module 11 is connected via vacuum gate vales 19 to 22 to the process modules 12 to 15. Moreover, the interior of the loader module 16 is held at atmospheric pressure, while the interior of the transfer module 11 is held in a vacuum. Accordingly, the load lock modules 17 and 18 have vacuum gate valves 23 and 24 at respective connections to the transfer module 11 and have atmospheric door valves 25 and 26 at respective connections to the loader module 16, so that the load-lock modules 17 and 18 act as vacuum preliminary transfer chambers capable of adjusting internal pressures thereof. Moreover, the load-lock modules 17 and 18 have wafer mounting stages 27 and 28, respectively, on each of which a wafer W transferred between the loader module 16 and the transfer module 11 is temporarily mounted.

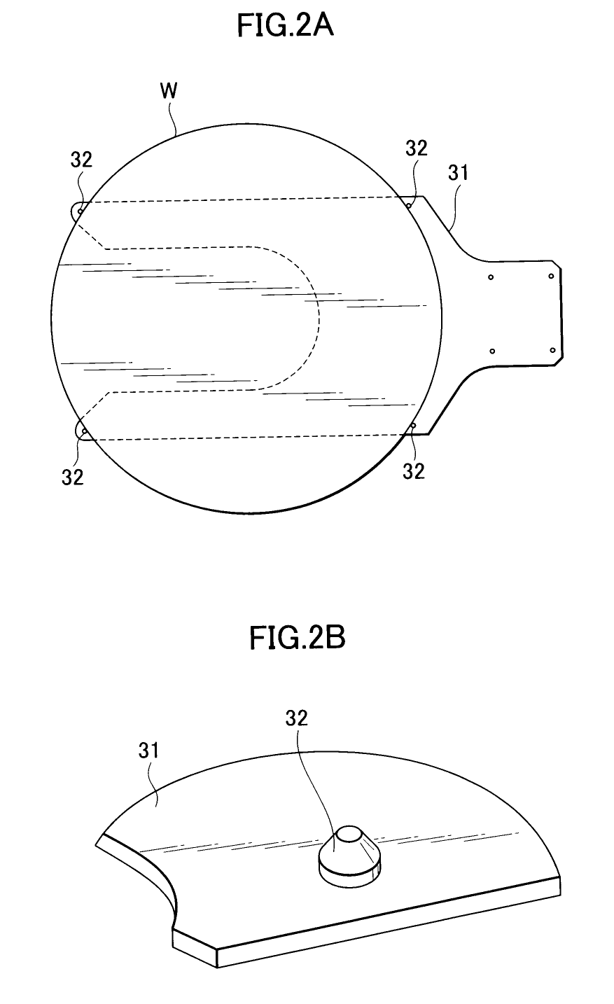

The transfer module 11 has therein a substrate transfer unit 29 (substrate transfer member) of a frog leg type that is constructed such as to be able to bend, extend, and whirl about a pivot thereof. The substrate transfer unit 29 has a transfer arm 30 (substrate transfer member) that is constructed such as to be able to extend and retract horizontally and turn, and a two-pronged fork 31 (substrate transfer member) that is connected to a distal end of the transfer arm 30 and supports a wafer W. As shown in FIG. 2A, the fork 31 has four tapered pads 32 (substrate transfer members, or abutment members) that support the wafer W with a predetermined space left between the wafer W from the front surface of the fork 31. As shown in FIG. 2B, each of the tapered pads 32 is formed by joining a truncated conical member to a cylindrical member. The four tapered pads 32 of the fork 31 are disposed along a peripheral portion (bevel) of the wafer W. The truncated conical portions of the respective tapered pads 32 abut on the peripheral portion of the wafer W so as to prevent the wafer W from becoming displaced relative to the fork 31.

Referring again to FIG. 1, the substrate transfer unit 29 transfers wafers W between the process modules 12 to 15 and the load-lock modules 17 and 18.

To the loader module 16 are connected three FOUP (Front Opening Unified Pod) mounting stages 34 on which respective FOUPs 33 as containers each housing 25 wafers W are mounted, and an orienter 35 that pre-aligns the position of each wafer W transferred out from the FOUP 33, as well as the above described load-lock modules 17 and 18.

The loader module 16 has a substrate transfer unit 36 (substrate transfer member) that is disposed therein and transfers wafers W, and three load ports 37 through which wafers W are transferred and which are disposed on a side wall of the loader module 16 such as to correspond to the respective FOUP mounting stages 34. The substrate transfer unit 36 has a transfer arm 38 (substrate transfer member) that is able to extend and retract horizontally and turn, and a two-pronged fork 39 (substrate transfer member) that is connected to a distal end of the transfer arm 38 and supports a wafer W. The fork 39 has a similar construction to the fork 31. By extending, retracting, and turning the transfer arm 38, the substrate transfer unit 36 moves the fork 39 supporting a wafer W to a desired position, whereby the wafer W is transferred to a desired position. Specifically, the substrate transfer unit 36 removes each wafer W from the FOUPs 33 mounted on the FOUP mounting stages 34 via the load port 37 and transfers the removed wafer W into the load-lock modules 17 and 18 and the orienter 35.

Moreover, the substrate processing system 10 has a system controller (not shown) that controls operation of the component elements, and an operation panel 40 disposed at one end of the loader module 16 as viewed in the longitudinal direction thereof. The system controller controls operation of the component elements according to programs associated with various kinds of processing. The operation panel 40 displays operating states of the component elements and receives operation inputs from an operator.

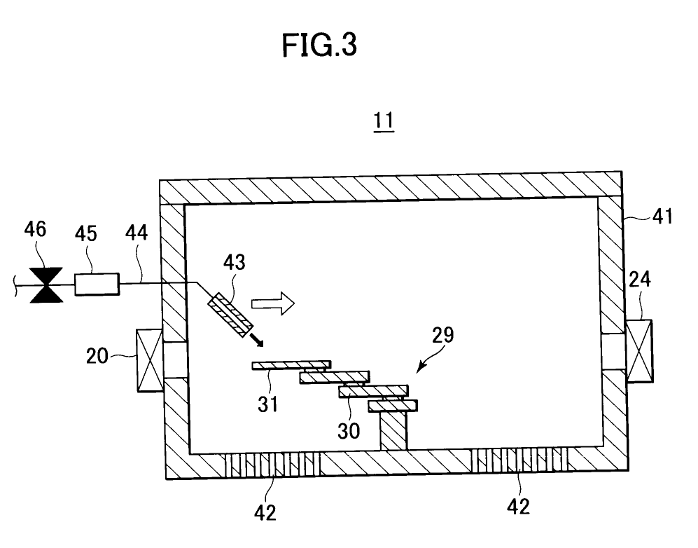

FIG. 3 is a sectional view taken along line III-III of FIG. 1.

As shown in FIG. 3, the transfer module 11 has a chamber 41, and an exhaust port 42 through which gas in the chamber 41 is exhausted. The above described transfer unit 29 is disposed inside the chamber 41.

In the chamber 41, a cleaning agent jetting nozzle 43 is disposed obliquely above the fork 31. The cleaning agent jetting nozzle 43 moves horizontally (in the direction indicated by the outline arrow in FIG. 3) inside the chamber 41. The cleaning agent jetting nozzle 43 and the fork 31 thus move parallel to and relative to each other.

Moreover, the cleaning agent jetting nozzle 43 communicates with a cleaning agent supply pipe 44, which is connected to a cleaning agent supply device (not shown) via a heater 45 and a pulse generator 46 comprised of a valve.

The cleaning agent supply device supplies a cleaning agent (cleaning gas), in which a cleaning substance in two-phases of a liquid phase and a vapor phase (hereinafter referred to merely as “two-phase”), such as pure water, and an inert gas such as nitrogen gas are mixed, to the cleaning agent jetting nozzle 43 via the heater 45 and the cleaning agent supply pipe 44. The cleaning agent jetting nozzle 43 jets the supplied cleaning agent toward the front surface of the fork 31, in particular, toward the truncated conical portions of the taper pads 32 (hereinafter referred to merely as the “front surface of the fork 31 or the like”) . The cleaning agent jetting nozzle 43 thus acts as a cleaning agent jetting device.

Here, the heater 45 heats the cleaning agent, in particular, nitrogen gas. Moreover, the pulse generator 46 causes the flow rate of the cleaning agent to fluctuate like pulse waves by opening and closing the valve. That is, the pulse generator 46 causes pressure fluctuations like pulse waves to occur. Thus, the cleaning agent jetted from the cleaning agent jetting nozzle 43 toward the front surface of the fork 31 or the like contains two-phase pure water and a high-temperature nitrogen gas (high-temperature gas) that fluctuate in pressure like pulse waves. It should be noted that a cleaning agent vibrating device that applies ultrasonic vibrations to the cleaning agent may be disposed part way along the cleaning agent supply pipe 44.

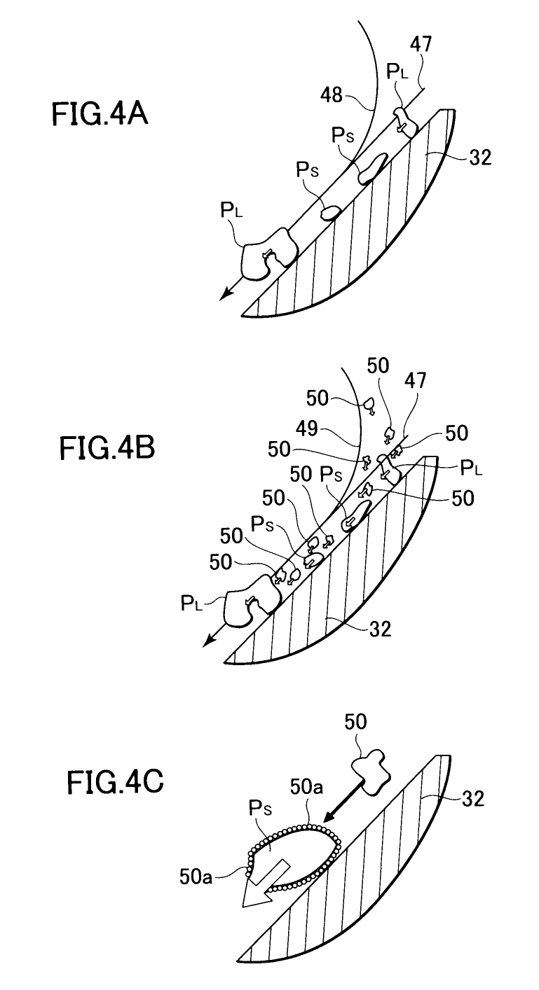

In general, foreign matter such as particles and polymer is attached to a rear surface and a peripheral portion of a wafer W on which the etching processing has been carried out. The foreign matter attached to the rear surface and the peripheral portion of the wafer W becomes attached to the front surface of the fork 31 or the like when the wafer W is being transferred. The foreign matter is of various sizes. When a gas is jetted toward the front surface of the fork 31 or the like to which the foreign matter is attached, a boundary layer 47 arises on the front surface of the fork 31 or the like (FIG. 4A). In the boundary layer 47, gas hardly flows. Here, relatively large foreign matter P_{L} partially projects out from the boundary layer 47, and hence the foreign matter P_{L} contacts a gas 48 and separates from the front surface of the fork 31 or the like due to viscous force of the gas 48. On the other hand, relatively small foreign matter P_{S} does not project out from the boundary layer 47, and hence the foreign matter P_{S} is not exposed to viscous force of the gas 48 and thus does not separate from the front surface of the fork 31 or the like.

Accordingly, in the transfer module 11, the cleaning agent jetting nozzle 43 jets the above-mentioned cleaning agent, i.e. the two-phase pure water and the high-temperature nitrogen gas toward the front surface of the fork 31 or the like to which the foreign matter is attached. At this time, the boundary layer 47 arises on the front surface of the fork 31 or the like due to the jetted high-temperature nitrogen gas 49, and the jetted high-temperature nitrogen gas 49 removes the relatively large foreign matter P_{L} partially projecting out from the boundary layer 47 through thermal stress and viscous force. Because liquid can enter a boundary layer, liquid-phase part of the jetted two-phase pure water 50 enters the boundary layer 47 (FIG. 4B).

Part of the pure water 50 having entered the boundary layer 47 turns into a number of minute water particles 50a and becomes attached to the periphery of the relatively small foreign matter P_{S} not projecting out from the boundary layer 47 (FIG. 4C). When the water particles 50a become attached to the periphery of the relatively small foreign matter P_{S} not projecting out from the boundary layer 47 with no space left, attractive forces such as van der Waals' forces acting between molecules and atoms constituting the fork 31 and the tapered pads 32 and molecules and atoms constituting the small foreign matter P_{S} decrease. This makes it easier for the foreign matter P_{S} to separate from the front surface of the fork 31 or the like. Moreover, part of the pure water 50 having entered the boundary layer 47 which does not turn into the minute pure water particles 50a collides with the foreign matter P_{S} and gives a physical shock to the foreign matter P_{S} As a result, not only the relatively large foreign matter P_{L} partially projecting out from the boundary layer 47 but also the relatively small foreign matter P_{S} not projecting out from the boundary layer 47 can be removed. Thus, the foreign matter attached to the front surface of the fork 31 or the like can be completely removed.

It should be noted that gas convection occurs in the boundary layer 47 although it is slight, and hence even if the pure water 50 does not collide with the foreign matter P_{S} to the periphery of which the pure water particles 50a are attached with no space left, the foreign matter P_{S} moves through the convention and is removed.

Moreover, if the pure water 50 attached to the front surface of the fork 31 or the like becomes attached to a rear surface and a peripheral portion of a wafer W when the wafer W is being transferred, and the attached pure water 40 evaporates over a long time, then watermarks may arise on the rear surface and the peripheral portion of the wafer W. However, because the high-temperature nitrogen gas 49 is jetted to the front surface of the fork 31 or the like, the pure water 50 attached to the front surface of the fork 31 or the like immediately evaporates. Thus, the pure water 50 does not become attached to the rear surface and the peripheral portion of the wafer W, and hence no watermarks arise there. It should be noted that in an evacuated environment, the boiling point of the pure water 50 lowers, and hence the pure water 50 attached to the front surface of the fork 31 or the like reliably evaporates. Thus, the pure water 50 can be efficiently exhausted out of the chamber 41, and hence watermarks can be reliably prevented from arising.

Moreover, in the transfer module 11, because the cleaning agent jetted toward the front surface of the fork 31 or the like fluctuates in pressure like pulse waves, the physical shock given to the foreign matter by the pure water 50 can be increased. As a result, the removal of the foreign matter from the front surface of the fork 31 or the like can be promoted. If ultrasonic vibrations are applied to the cleaning agent, the physical shock given to the foreign matter by the pure water 50 can be further increased. Further, if the cleaning agent, in particular, the high-temperature nitrogen gas 49 fluctuates in pressure like pulse waves, the thickness of the boundary layer 47 also fluctuates in response to the pressure fluctuation. The fluctuations in the thickness of the boundary layer 47 give vibrations to the foreign matter, thus promoting the removal of the foreign matter.

In the transfer module 11, gas is exhausted out of the chamber 41 through the exhaust port 42. Thus, the cleaning agent jetted from the cleaning agent jetting nozzle 43 and having caught therein the foreign matter removed from the front surface of the fork 31 or the like is exhausted through the exhaust port 42. As a result, the removed foreign matter can be prevented from floating in the chamber 41 and becoming attached to the front surface of the fork 31 or the like again. Moreover, in the transfer module 11, a nozzle (not shown) for sucking the cleaning agent having the removed foreign matter caught therein may be disposed above the fork 31 in the chamber 41. In this case, the cleaning agent having the removed foreign matter caught therein is immediately sucked, and hence the removed foreign matter can be reliably prevented from floating in the chamber 41.

Moreover, the transfer module 11 may have a gas supply device that supplies gas into the chamber 41. In this case, by supplying gas into the chamber 41 from the gas supply device, the pressure in the chamber 41 can be controlled to a pressure suitable for jetting of the cleaning agent by the cleaning agent jetting nozzle 43, and hence the foreign matter attached to the front surface of the fork 31 or the like can be efficiently removed.

According to the present embodiment, the two-phase pure water 50 and the high-temperature nitrogen gas 49 are jetted toward the front surface of the fork 31 or the like. The high-temperature nitrogen gas 49 removes relatively large foreign matter P_{L} attached to the front surface of the fork 31 or the like through thermal stress and viscous force. The boundary layer 47 in which the high-temperature nitrogen gas 49 does not flow arises on the front surface of the fork 31 or the like due to the jetted high-temperature nitrogen gas 49, and the liquid-phase pure water 50 enters the boundary layer 47 and becomes attached to the periphery of relatively small foreign matter P_{S} in the boundary layer 47. When the pure water 50 becomes attached to the periphery of the relatively small foreign matter P_{S}, attracting forces such as van del Waals' forces between the foreign matter P_{S} and the front surface of the fork 31 or the like decrease. Further, the liquid-phase pure water 50 having entered the boundary layer 47 collides with the foreign matter P_{S} and gives a physical shock to the foreign matter P_{S}. As a result, the relatively small foreign matter P_{S} can also be removed, and the foreign matter attached to the front surface of the fork 31 or the like can be completely removed. Moreover, because it is unnecessary to stop the transfer arm 30 and clean the front surface of the fork 31 or the like by hand, the foreign matter attached to the front surface of the fork 31 or the like can be completely removed without bringing about a decrease in the throughput.

In the above described transfer module 11, pure water is used as the cleaning substance of the cleaning agent, the cleaning substance is not limited to this. For example, an organic solvent (ethanol, methanol, ethylene glycol, isopropyl alcohol, or the like), function water, surface-active agent, or cleaning solution (SC1, SC2, BHF, DHF, or the like) may be used. The boiling points of these cleaning substances are relatively low, and hence they can easily be in two phases of a vapor phase and a liquid phase. Moreover, these cleaning substances are apt to become attached to foreign matter, and hence attractive forces (e.g. van den Waals' forces) between the foreign matter and a wafer W can be reliably reduced. In particular, ethylene glycol is similar in composition to polymer, and hence if an ethylene glycol is used as the cleaning substance in a case where foreign matter is composed mainly of polymer, the foreign matter can be removed not only through thermal stress and viscous force and using a decrease in van del Waals' forces as described above, but also using solution to the liquid-phase ethylene glycol, so that the removal of the foreign matter can be further promoted.

Moreover, in the above described transfer module 11, nitrogen gas is used as the inert gas of the cleaning agent, but from the standpoint of viscous force, it is preferred that the amount of molecules constituting gas is as largest as possible, and for example, argon gas and krypton gas may be used.

Next, a description will be given of a cleaning process for the front surface of the fork or the like carried out by the substrate processing system according to the present embodiment.

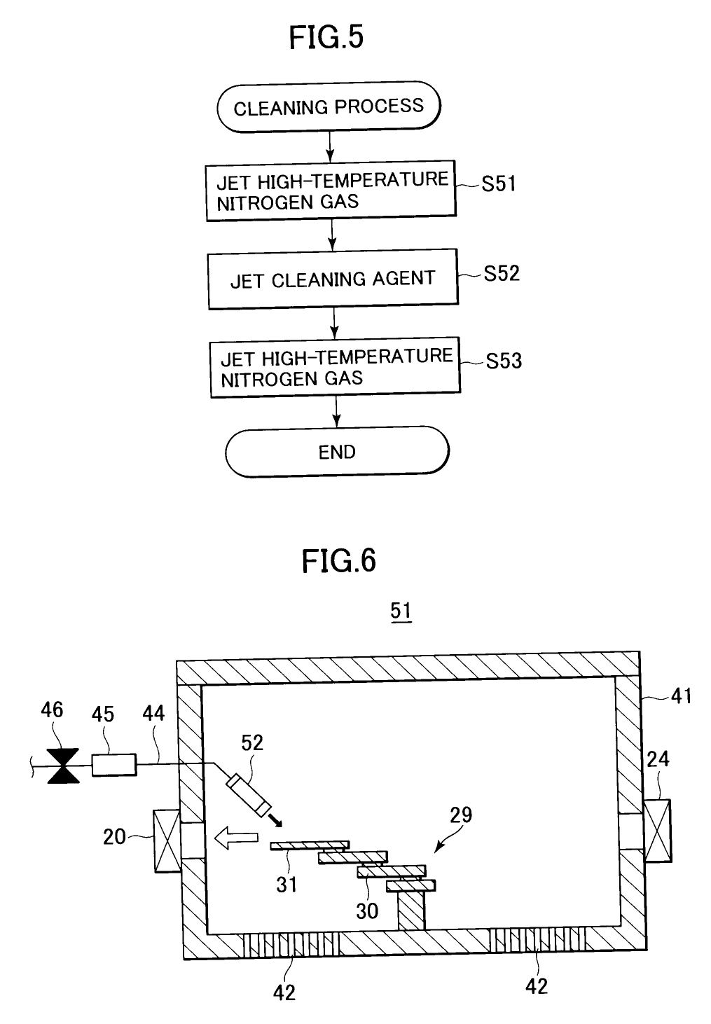

FIG. 5 is a flow chart of the cleaning process for the front surface of the fork or the like according to the present embodiment.

As shown in FIG. 5, first, only the high-temperature nitrogen gas 49 is jetted from the cleaning agent jetting nozzle 43 toward the front surface of the fork 31 or the like to which foreign matter is attached (step S51). Here, the high-temperature nitrogen gas 49 removes relatively large foreign matter P_{L} attached to the front surface of the fork 31 or the like through thermal stress and viscous force and transfers heat to the front surface of the fork 31 or the like, so that the temperature of the front surface of the fork 31 or the like is increased.

Next, the cleaning agent is jetted from the cleaning agent jetting nozzle 43 toward the front surface of the fork 31 or the like (step S52). Here, the jetted liquid-phase pure water 50 enters the boundary layer 47 and removes relatively small foreign matter P_{S} attached to the front surface of the fork 31 or the like. At this time, the pure water 50 becomes attached to the front surface of the fork 31 or the like, but because the temperature of the front surface of the fork 31 or the like was raised in the step S51, the attached pure water 50 immediately evaporates. Moreover, at this time as well, because the high-temperature nitrogen gas 49 is jetted toward the front surface of the fork 31 or the like, the evaporation of the attached pure water 50 is promoted.

Then, only the high-temperature nitrogen gas 49 is jetted from the cleaning agent jetting nozzle 43 toward the front surface of the fork 31 or the like (step S53). As a result, the evaporation of the attached pure water 50 is further promoted, and hence the pure water 50 completely evaporates.

Then, the present process is brought to an end.

According to the cleaning process of FIG. 5, after the high-temperature nitrogen gas 49 is jetted from the cleaning agent jetting nozzle 43 toward the front surface of the fork 31 or the like, the cleaning agent is jetted, and then the high-temperature nitrogen gas 49 is jetted. Thus, the foreign matter attached to the front surface of the fork 31 or the like can be completely removed, and the pure water 50 attached to the front surface of the fork 31 or the like can be completely evaporated. As a result, watermarks can be reliably prevented from arising.

Next, a description will be given of a substrate processing system according to a second embodiment of the present invention.

The substrate processing system according to the present embodiment differs from the substrate processing system according to the first embodiment only in the construction of the cleaning agent jetting nozzle disposed in the chamber of the transfer module. Features of the construction and operation that are the same as in the first embodiment will thus not be described, only features that are different from those of the first embodiment being described below.

FIG. 6 is a sectional view schematically showing the construction of a transfer module as a substrate transfer apparatus provided in the substrate processing system according to the present embodiment.

As shown in FIG. 6, the transfer module 51 (substrate transfer apparatus) has the chamber 41, and the exhaust port 42 through which gas is exhausted out of the chamber 41. The above described substrate transfer unit 29 is disposed inside the chamber 41.

In the chamber 41, a cleaning agent jetting nozzle 52 is disposed obliquely above the fork 31. The fork 31 moves horizontally (in the direction indicated by the outline arrow in FIG. 6) inside the chamber 41. The cleaning agent jetting nozzle 52 and the fork 31 thus move parallel to and relative to each other.

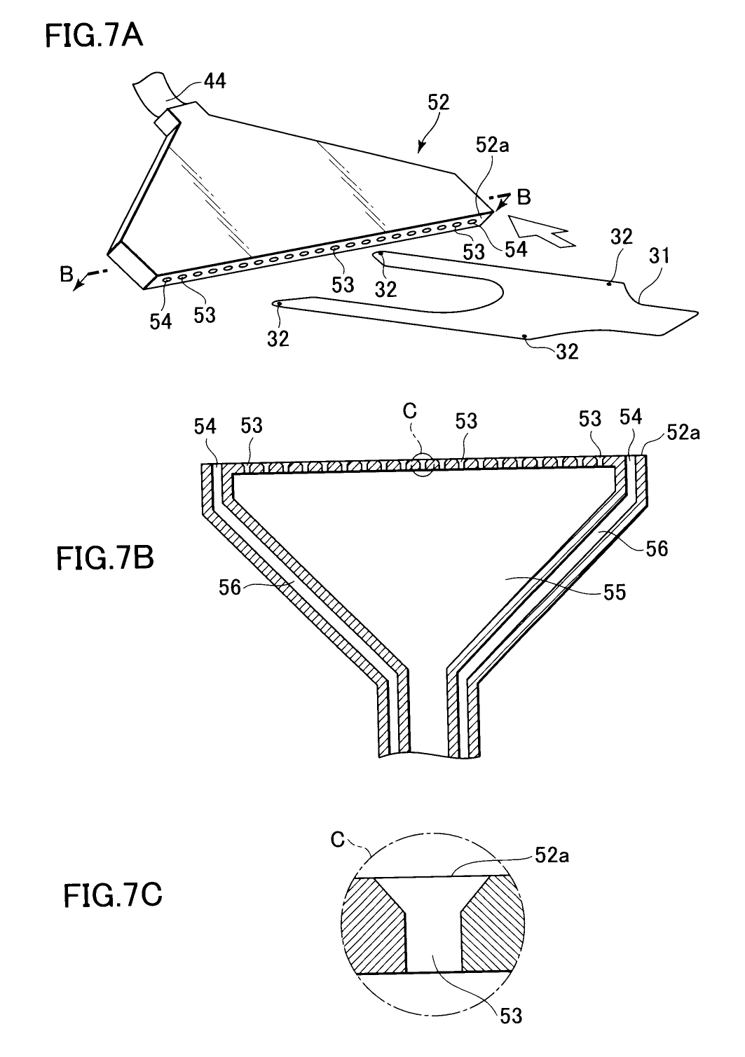

FIGS. 7A to 7C are views schematically showing the construction of the cleaning agent jetting nozzle shown in FIG. 6, in which FIG. 7A shows the positional relationship between the fork and the cleaning agent jetting nozzle, FIG. 7B is a sectional view taken along line B-B of FIG. 7A, and FIG. 7C is an enlarged view of a portion C shown in FIG. 7B.

As shown in FIG. 7A, the cleaning agent jetting nozzle 52 is comprised of a spatula-shaped member and has in a bottom portion thereof an opposing surface 52a opposed obliquely to the front surface of the fork 31. A plurality of cleaning agent jetting holes 53 are formed in the opposing surface 52a. A cleaning agent is jetted from the cleaning agent jetting nozzles 53. The opposing surface 52a extends perpendicularly to the direction in which the fork 31 moves (the direction indicated by the outline arrow in FIG. 7A). Because the length of the opposing surface 52a in the perpendicular direction thereof is not less than the length of the fork 31 in the perpendicular direction thereof, the cleaning agent jetting nozzle 52 can scan the overall front surface of the fork 31 using the cleaning agent jetted from the cleaning agent jetting nozzles 53. Moreover, a plurality of intake air holes 54 are formed in the opposing surface 52a. Thus, the intake air holes 54 are opened such as to face the front surface of the fork 31. The intake air holes 54 suck foreign matter removed from the front surface of the fork 31 or the like as well as the cleaning agent.

As shown in FIG. 7B, the cleaning agent jetting nozzle 52 has a buffer portion 55 that communicates with the cleaning agent jetting holes 53, and an intake air path 56 that communicates with the intake air holes 54. The intake air path 56 communicates a suction device (not shown). As shown in FIG. 7C, opening portions of the cleaning agent jetting holes 53 are formed such as to widen toward the end. The cleaning agent jetting holes 53 thus can uniformly jet the cleaning agent toward the front surface of the fork 31 or the like.

Referring again to FIG. 6, the cleaning agent jetting holes 53 of the cleaning agent jetting nozzle 52 communicate with the cleaning agent supply pipe 44 via the buffer portion 55, and the cleaning agent supply pipe 44 is connected to a cleaning agent supply device (not shown) via the heater 45 and the pulse generator 46.

In the present embodiment as well, the cleaning agent supply device supplies a cleaning agent, in which a cleaning substance in two phases of a liquid phase and a vapor phase, such as pure water, and an inert gas such as nitrogen gas are mixed, to the buffer portion 55 via the heater 45 and the cleaning agent supply pipe 44. The cleaning agent supplied to the buffer portion 55 is then jetted toward the front surface of the fork 31 or the like via the cleaning agent jetting holes 53. The cleaning agent jetting nozzle 53 thus acts as a cleaning agent jetting device. At this time, as is the case with the first embodiment, relatively large foreign matter P_{L} attached to the front surface of the fork 31 or the like is removed through thermal stress and viscous force of a high-temperature nitrogen gas, and relatively small foreign matter P_{S} whose van der Waals' force has been decreased due to pure water particles attached thereto is removed through collisions with pure water.

Moreover, as is the case with the first embodiment, the cleaning agent having caught the foreign matter therein as well as gas is exhausted out of the chamber 41 through the exhaust port 42 so as to prevent the foreign matter from becoming attaching to the front surface of the fork 31 or the like again.

Further, in the cleaning agent jetting nozzle 52, the cleaning agent jetting holes 53 from which the cleaning agent is jetted are provided in the opposing surface 52a opposed obliquely to the front surface of the fork 31 or the like as described above, and hence the cleaning agent jetting nozzle 52 jets the cleaning agent obliquely to the front surface of the fork 31 or the like.

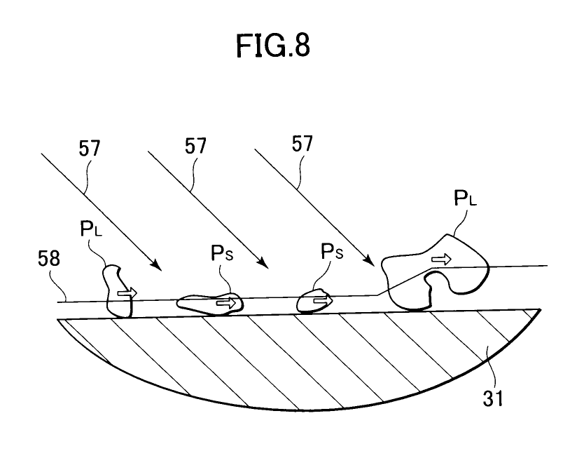

Here, as shown in FIG. 8, the obliquely jetted cleaning agent 57 pushes the boundary layer 53 aside along the front surface of the fork 31 or the like, and hence part of the relatively small foreign matter P_{S} can be exposed from the boundary layer 58. As a result, the thermal stress and viscous force of the high-temperature nitrogen gas can be made to act on the relatively small foreign matter P_{S}, so that the relatively small foreign matter P_{S} can be reliably removed.

If the cleaning agent is jetted at the same time toward the entire front surface of the fork 31, the removed foreign matter may be pressed against the front surface of the fork 31 or the like in the current of the cleaning agent and become attached to the front surface of the fork 31 or the like. However, in the transfer module 51, because the cleaning agent jetting nozzle 52 and the fork 31 move parallel to and relative to each other as described above, the cleaning agent is not jetted at the same time toward the entire front surface of the fork 31, and hence the removed foreign matter is not pressed against toward the front surface of the fork 31 again. Moreover, as described above, the intake air holes 54 suck the foreign matter removed from the front surface of the fork 31 as well as the cleaning agent. As a result, the foreign matter can be reliably prevented from becoming attached to the front surface of the fork 31 again.

It should be noted that the sectional shape of each cleaning agent jetting hole 53 of the cleaning agent jetting nozzle 52 is not limited to being circular as shown in FIG. 7A, but rather may instead be triangular, square, star-shaped, or the like.

Moreover, in the present embodiment as well, the same effects as those in the above described first embodiment can be obtained by carrying out the cleaning process carried out in the above described first embodiment.

Moreover, although in the above described embodiments, the cleaning agent in which a two-phase cleaning substance and an inert gas are mixed is used, only a two-phase cleaning substance may be used as the cleaning agent without mixing it with an inert gas. With this arrangement as well, foreign matter attached to the front surface of the fork 31 or the like can be completely removed. In this case, because the heater 45 does not have to be provided part way along the cleaning agent supply pipe 44, the construction of the cleaning apparatus can be simplified.

Moreover, although in the above described embodiments, the cleaning agent jetting nozzle 43 (52) is disposed only above the fork 31 in the transfer module 11 (51), a similar cleaning agent jetting nozzle may also be disposed above the fork 39 in the loader module 16. With this arrangement, foreign matter attached to the fork 39 in the loader module 16 can also be completely removed. It should be noted that the cleaning agent jetting nozzle may be disposed above a member that contacts a rear surface or a peripheral portion of a wafer W. In this case as well, foreign matter attached to the member can be completely removed.

Moreover, although in the above described embodiments, the cleaning agent jetting nozzle 43 (52) is disposed only above the fork 31 in the transfer module 11 (51), a similar cleaning agent jetting nozzle may also be disposed above the wafer mounting stage 27 (28) in the load-lock module 17 (18). In this case, in the load-lock module 17 (18), foreign matter attached to the front surface of the fork 31 or the like in the transfer module 11 (51), and foreign matter attached to the fork 39 in the loader module 16 can be completely removed. It should be noted that when foreign matter attached to the front surface of the fork 31 or the like is to be removed, the load-lock module 17 (18) lies in an evacuated environment, e.g. vacuum environment, and hence the pure water 50 attached the front surface of the fork 31 or the like reliably evaporates. On the other hand, when foreign matter attached to the fork 39 is to be removed, the load-lock module 17 (18) lies in an atmospheric environment. It is thus preferred that the fork 39 is heated by a heating mechanism such as a lamp (not shown) so as to reliably evaporate pure water (not shown) attached to the fork 39. To separate the pure water from the fork 39, the fork 39 may be vibrated using a vibration mechanism such as an ultrasonic vibrator (not shown). This can reliably prevent watermarks from arising.

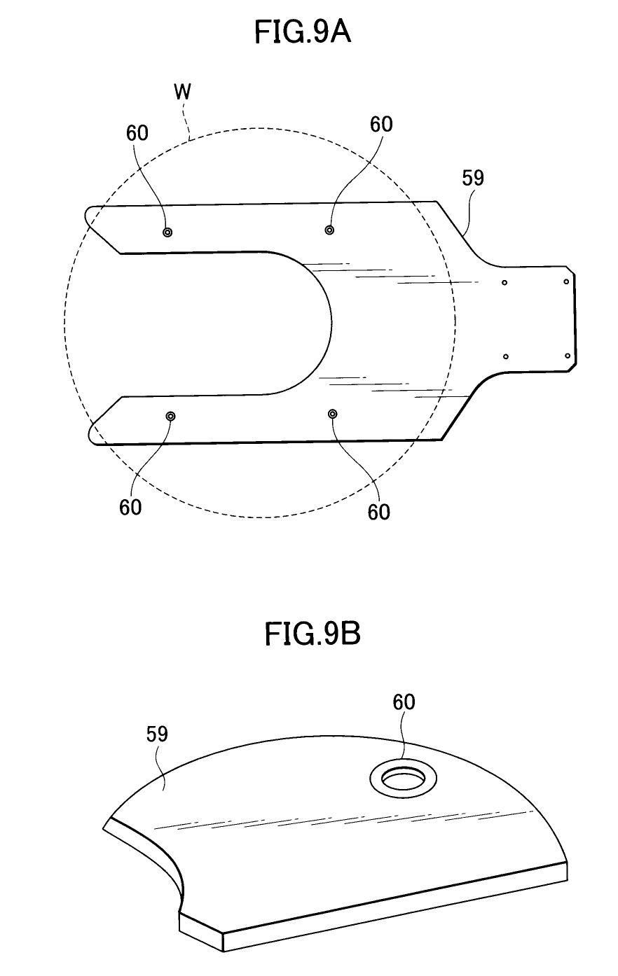

Moreover, although in the above described embodiments, a wafer W is supported by abutting it on the truncated conical portions of the four tapered pads 32 provided in the fork 31, a fork 59 (substrate transfer member) may be provided with four O-rings 60 (substrate transfer members or abutment members), as shown in FIGS. 9A and 9B, so that a wafer W can be supported by abutting it on top portions of the O-rings 60. Here, the wafer W is supported through the attracting force of the O-rings 60, so that displacement of the wafer W relative to the fork 59 can be prevented. In this case, in the above described embodiments, a cleaning agent or the like is jetted from a cleaning agent jetting nozzle toward the O-rings 60, so that the same effects as those in the above described embodiment can be obtained. It should be noted that, to restore the attracting force of the O-rings 60, a gas for softening the O-rings 60, i.e. a gas containing fatty acid ester-based components may be mixed in a cleaning agent or the like jetted toward the O-rings 60.

Further, the substrates subjected to the predetermined processing according to the above described embodiments are not limited to being semiconductor wafers, but rather may instead be any of various glass substrates used in LCDs (Liquid Crystal Displays), FPDs (Flat Panel Displays) or the like.

It is to be understood that the object of the present invention may also be accomplished by supplying a computer with a storage medium in which a program code of software, which realizes the functions of any of the above described embodiments is stored, and causing a CPU of the computer to read out and execute the program code stored in the storage medium.

In this case, the program code itself read from the storage medium realizes the functions of any of the above described embodiments, and hence the program code and the storage medium on which the program code is stored constitute the present invention.

Examples of the storage medium for supplying the program code include a RAM, an NV-RAM, a floppy (registered trademark) disk, a hard disk, a magnetic-optical disk, an optical disk such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program code may be supplied by downloading from another computer, a database, or the like, not shown, connected to the Internet, a commercial network, a local area network, or the like.

Further, it is to be understood that the functions of any of the above described embodiments may be accomplished not only by executing a program code read out by a computer, but also by causing an OS (operating system) or the like which operates on a CPU to perform a part or all of the actual operations based on instructions of the program code.

Further, it is to be understood that the functions of any of the above described embodiments may be accomplished by writing a program code read out from the storage medium into a memory provided in an expansion board inserted into a computer or a memory provided in an expansion unit connected to the computer and then causing a CPU or the like provided in the expansion board or the expansion unit to perform a part or all of the actual operations based on instructions of the program code.

Further, the form of the program may be an object code, a program executed by an interpreter, or script data supplied to an OS.

What is claimed is:

1. A method of cleaning a substrate transfer member that transfers a substrate, comprising:
a cleaning gas jetting step of jetting a cleaning gas containing a cleaning substance in two phases of a vapor phase and a liquid phase and a high-temperature gas toward the substrate transfer member.

2. A cleaning method as claimed in claim 1, wherein in said cleaning gas jetting step, the cleaning gas is jetted obliquely to the substrate transfer member.

3. A cleaning method as claimed in claim 1, wherein in said cleaning gas jetting step, a flow rate of the cleaning gas is fluctuated like pulse waves.

4. A cleaning method as claimed in claim 1, comprising a first high-temperature gas jetting step of jetting a high-temperature gas toward the substrate transfer member before said cleaning gas jetting step.

5. A cleaning method as claimed in claim 1, comprising a second high-temperature gas jetting step of jetting a high-temperature gas toward the substrate transfer member after said cleaning gas jetting step.

6. A cleaning method as claimed in claim 1, wherein
the substrate transfer member comprises abutment members that come into abutment with the substrate, and
in said cleaning gas jetting step, the cleaning gas is jetted toward the abutment members.

7. A cleaning method as claimed in claim 1, wherein the cleaning substance is one selected from a group consisting of water, organic solvent, function water, surface-active agent, and cleaning solution.

8. A substrate transfer apparatus including a substrate transfer member that transfers a substrate, comprising:
a jetting device adapted to jet a cleaning gas containing a cleaning substance in two phases of a vapor phase and a liquid phase and a high-temperature gas toward the substrate transfer member.

9. A substrate processing system comprising a substrate processing apparatus adapted to carry out processing on a substrate, and a substrate transfer apparatus as claimed in claim 8.
